(19) United States
(12) Patent Application Publication
(10) Pub. No.: US 2005/0268588 A1
(43) Pub. Date: Dec. 8, 2005

(54) Mower cutting deck having blow-out baffle, and method of using same

(76) Inventors: Jerrod N. Winter, Cottage Grove, MN (US); Jeffrey B. Kallevig, Eden Prairie, MN (US)

Correspondence Address: MUETING, RAASCH & GEBHARDT, P.A., P.O. BOX 581415, MINNEAPOLIS, MN, 55458, US

(21) Appl. No.: 10/860,550

(22) Filed: Jun. 3, 2004

(51) Int. Cl. A01D 67/00

(52) U.S. Cl. 56/320.1

(57) ABSTRACT

A cutting deck assembly incorporating a flexible, resilient blow-out baffle and method for using same. The baffle may attach to the deck assembly such that a first elongate edge of the baffle is at or near a lower edge of a deck sidewall. A second elongate edge of the baffle may be suspended beneath an upper surface of the deck assembly. The baffle may be operable to move between a first configuration, in which the second elongate edge is at a first distance from a ground surface, and a second configuration, in which the second elongate edge is at a second distance from the ground surface, wherein the second distance is less than the first distance.

### TECHNICAL FIELD

The present invention relates generally to vegetation mowers and, more particularly, to a mower cutting deck having a blow-out baffle, and to a method of using the same.

### BACKGROUND

Rotary mower cutting decks that include one or more spindles (e.g., three spindles) each driving a cutting blade are typically known. Such cutting decks generally include an upper surface to which is attached one or more downwardly extending peripheral sidewalls. The upper surface and sidewalls may define a partially enclosed housing containing the cutting blades. The housing is commonly attached to a tractor or other lawn vehicle. Power is provided to the spindles to rotate the cutting blades at a speed sufficient to sever grass and other vegetation located on a ground surface over which the deck passes.

Many cutting decks may also incorporate rigid vertical baffles offset from an outermost edge of the cutting blades. These baffles are typically welded to the underside of the deck.

In addition to creating desirable air flow patterns within the cutting deck, these vertical baffles may provide other benefits. For example, vertical baffles may provide air flow patterns that assist with mulching, bagging, and/or discharge of debris such as grass clippings, leaves, etc. Further, for example, vertical baffles may assist with reducing unintended ejection of air and debris from beneath the front of the deck (referred to as deck “blow-out”). Deck blow-out may, in some circumstances (e.g., when operating in bagging mode), require that an operator “chase” debris, e.g., make multiple passes over the same area, to ensure adequate debris retrieval and capture.

While effective for their intended purpose, rigid vertical baffles do have drawbacks. For instance, the quality of cut provided by vertical baffle-equipped cutting decks may vary as a function of the baffle height (the gap between the vertical baffle and the ground surface). A large gap may result in undesirable air flow within the deck, which may, in turn, potentially reduce mulching/bagging efficiency and/or increase deck blow-out. A smaller gap, on the other hand, while possibly improving air flow, may result in inadvertent contact of the baffle with undulations in the ground surface. Such contact may damage turf and, possibly, the cutting deck itself. Moreover, some rigid vertical baffle configurations may deflect the grass downwardly, potentially reducing the resulting quality of cut.

### SUMMARY

Embodiments of the present invention provide cutting decks that address these and other issues. For instance, in one embodiment, a deck assembly for cutting vegetation is provided that includes an upper surface, and a sidewall extending from the upper surface towards a ground surface. The upper surface and the sidewall partially surround one or more cutting chambers each operable to contain a cutting blade. The deck assembly also includes an elongate baffle attached to the deck assembly such that a first elongate edge of the baffle is at or near a lower edge of the sidewall, and a second elongate edge of the baffle is suspended beneath the upper surface. The baffle is operable to move between a first configuration, in which the second elongate edge is at a first distance from the ground surface, and a second configuration, in which the second elongate edge is at a second distance from the ground surface, wherein the second distance is less than the first distance.

In another embodiment, a deck assembly for cutting vegetation is provided and includes an upper surface and a sidewall extending away from the upper surface towards a ground surface. The upper surface and the sidewall partially surround one or more cutting chambers each operable to contain a cutting blade. The deck assembly also includes a cantilevered baffle comprising a first elongate edge, wherein the baffle is fixed to the sidewall such that the first elongate edge is at or near a lower edge of the sidewall and a second elongate edge of the baffle is suspended beneath the upper surface. The baffle is operable to deflect between a first configuration, wherein the second elongate edge of the baffle is located at a first distance above the ground surface, and a second configuration, wherein the second elongate edge is at a second distance above the ground surface, the first distance being greater than the second distance.

In still another embodiment, a method for operating a cutting deck assembly is provided. The method includes positioning the cutting deck assembly over a ground surface, wherein the cutting deck assembly includes an upper surface, and a sidewall extending away from the upper surface towards the ground surface. The upper surface and the sidewall partially surround one or more cutting chambers each operable to contain a cutting blade. The cutting deck assembly also includes an elongate baffle attached to the deck assembly such that a first elongate edge of the baffle is at or near a lower edge of the sidewall, and a second elongate edge of the baffle is suspended beneath the upper surface. The method further includes rotating the cutting blade, and moving the baffle from a first configuration, in which the second elongate edge is at a first distance from the ground surface, to a second configuration, in which the second elongate edge is at a second distance from the ground surface, wherein the second distance is less than the first distance.

The above summary of the invention is not intended to describe each embodiment or every implementation of the present invention. Rather, a more complete understanding of the invention will become apparent and appreciated by reference to the following detailed description and claims in view of the accompanying drawing.

### BRIEF DESCRIPTION OF THE VIEWS OF THE DRAWING

The present invention will be further described with reference to the figures of the drawing, wherein:

FIG. 1 is a perspective view of a mowing vehicle, e.g., riding lawn mower, incorporating a cutting deck and baffle assembly in accordance with one embodiment of the present invention;

FIG. 2 is a bottom plan view of the cutting deck of FIG. 1;

FIG. 3 is a partially exploded, lower perspective view of the cutting deck of FIG. 2 with some structure removed for clarity;

FIG. 4 is a partial section view of the cutting deck taken along line 4-4 of FIG. 2;

FIG. 5A is a diagrammatic side elevation view of a cutting deck without the baffle assembly of the present invention; and

FIGS. 5B-5C are diagrammatic side elevation views of a cutting deck and baffle in accordance with one embodiment of the present invention, wherein: FIG. 5B illustrates the cutting deck with the baffle deflected during normal operation; and FIG. 5C illustrates the embodiment of FIG. 5B with the baffle deflected upwardly to permit entry of lawn debris.

Unless otherwise stated herein, the figures of the drawing are not necessarily rendered to scale.

### DETAILED DESCRIPTION OF EXEMPLARY EMBODIMENTS

In the following detailed description of exemplary embodiments, reference is made to the accompanying views of the drawing which form a part hereof, and in which are shown by way of illustration specific embodiments in which the invention may be practiced. It is to be understood that other embodiments may be utilized and structural changes may be made without departing from the scope of the present invention.

Generally speaking, embodiments of the present invention are directed to blow-out baffles and to cutting decks/methods incorporating the same. These baffles may reduce the occurrence of air and debris blow-out from underneath the cutting deck, e.g., from beneath a front portion of the cutting deck. Moreover, blow-out baffles as described herein may be made from a relatively compliant and resilient material. Therefore, inadvertent contact between the baffle and the turf may result in little or no damage to either the turf or the mower. That is, compared to conventional cutting decks with rigid vertical baffles, damage to turf and/or the cutting deck (resulting from inadvertent baffle/turf contact) may be substantially reduced or eliminated with cutting decks/baffles of the present invention.

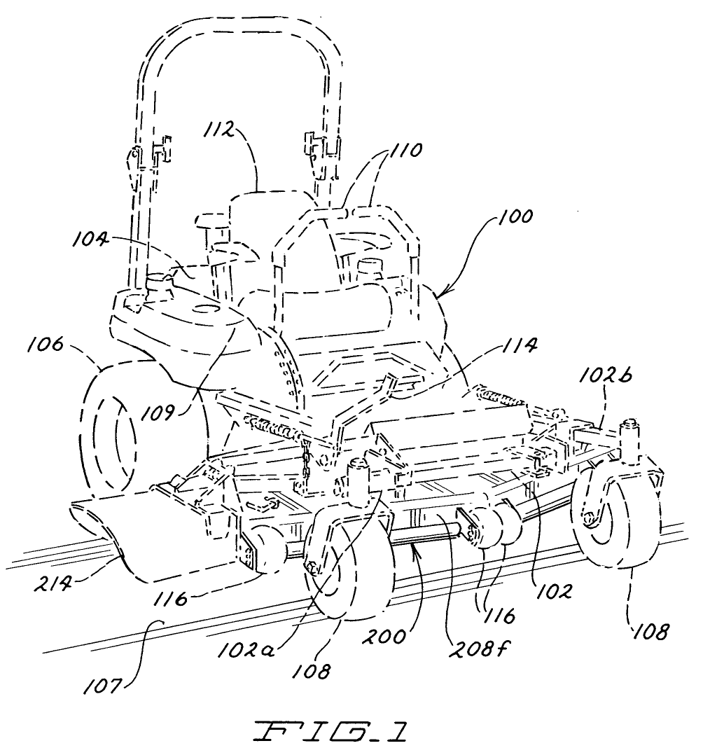

FIG. 1 illustrates a vegetation cutting deck assembly 200 (also referred to herein as deck 200) in accordance with one embodiment of the present invention as it may be incorporated on a self-propelled, ground maintenance vehicle, e.g., a zero-radius-turning (ZRT) riding lawn mower 100. While the invention is herein described with respect to riding ZRT mowers, those of skill in the art will realize that the invention is equally applicable to other mowing vehicles, e.g., walk-behind mowers, towed and gang mowers, etc., and to other vehicles to which a cutting deck may be attached, e.g., all terrain vehicles, skid-steer loaders.

While the general mower configuration is not necessarily central to the invention, an exemplary embodiment is briefly described below. FIG. 1 illustrates the mower 100 having a frame 102 supporting a prime mover, e.g., internal combustion engine 104. A left and a right ground engaging drive wheel 106 (only right wheel shown) may be rotatably coupled to left and right sides of a rear portion of the mower 100, respectively. The drive wheels 106 may be independently powered by the engine 104 (e.g., via one or more hydraulic motors, transmissions, or the equivalent) so that the drive wheels 106 may propel the mower 100 over a ground surface 107, e.g., grass, during operation.

One or more controls, e.g., left and right drive control levers 110 may also be provided. The drive control levers 110 are generally pivotally coupled to the mower 100 such that they may pivot forwardly and rearwardly under the control of an operator sitting in an operator's seat 112. The drive control levers 110 are operable to independently control speed and direction of the respective drive wheels 106 via manipulation of the mower's drive system as is known in the art. For example, incremental forward movement (e.g., pivoting about a transverse horizontal axis) of the left (or right) drive control lever 110 (from a neutral position) results in an incremental increase in rotational speed of the left (or right) drive wheel 106 in a forward direction. Similarly, incremental rearward movement of the left (or right) drive control lever 110 (from a neutral position) results in an incremental increase in rotational speed of the left (or right) drive wheel 106 in a rearward direction. While illustrated herein as incorporating separate drive control levers 110, other controls, e.g., single or multiple joysticks or joystick-type levers, steering wheels/bars, etc., may also be used without departing from the scope of the invention.

A pair of front swiveling caster wheels 108, connected to forwardly extending frame rails 102a and 102b, may support a front portion of the mower 100 in rolling engagement with the ground surface 107.

Although the illustrated mower has the drive wheels 106 in the rear and the caster wheels 108 in front, this configuration is not limiting. For example, other embodiments may reverse the location of the wheels, e.g., drive wheels in front and caster wheels in back. Moreover, other configurations may use different wheel configurations altogether, e.g., a tri-wheel configuration or a conventional front-wheel-steering configuration. Accordingly, other embodiments are possible without departing from the scope of the invention.

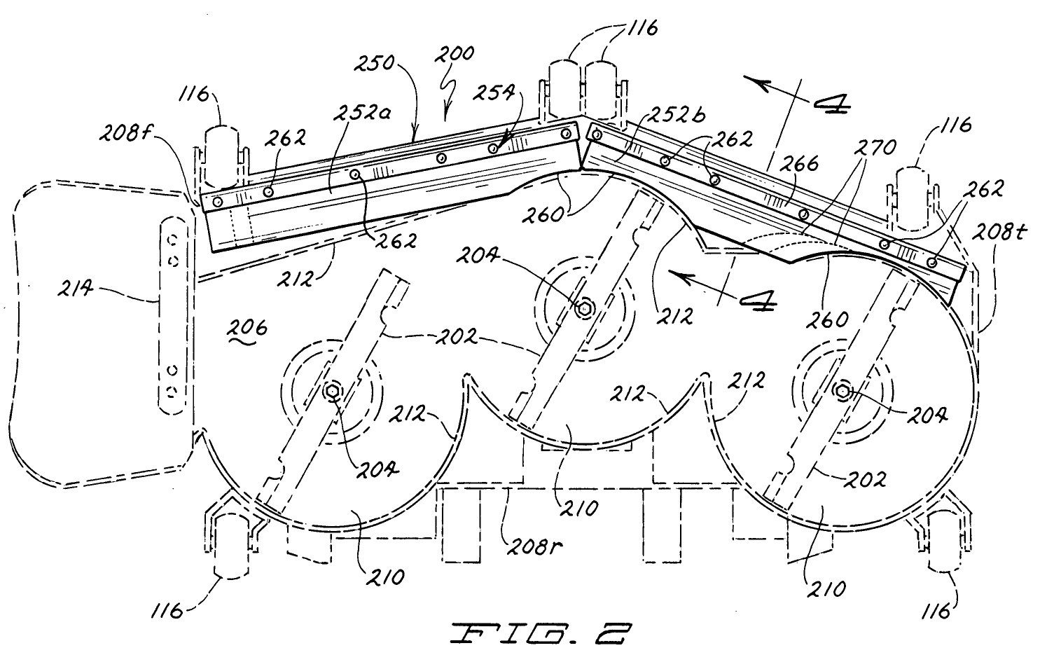

The cutting deck 200 may be mounted, in one embodiment, to the lower side of the frame 102 generally between the drive wheels 106 and the caster wheels 108 (sometimes referred to as a belly-mounted configuration). The cutting deck 200 may include one or more cutting blades 202 (see FIG. 2) that are operatively powered by the engine 104. Miscellaneous controls 109 permit operator control of various mower functions, e.g., throttle, blade engagement, etc.

During operation, power is selectively delivered to the cutting deck 200 and drive wheels 106, whereby the cutting blades 202 rotate at a speed sufficient to sever grass and other vegetation as the cutting deck 200 passes over the ground surface 107. Typically, the cutting deck 200 has an operator-selectable height-of-cut control 114 to allow adjustment of the cutting deck 200 height relative to the ground surface 107. The cutting deck 200 may optionally include deck rollers 116 to assist in supporting the cutting deck relative to the ground surface 107 during operation.

Other aspects/features of the mower 100 that are either not central to the invention or are readily known by those skilled in the art may also be included. However, such other aspects/features are not further discussed and/or illustrated herein.

As used herein, relative terms such as “left,” “right,” “fore,” “forward,” “aft,” “rearward,” “top,” “bottom,” “upper,” “lower,” “horizontal,” “vertical,” and the like are from the perspective of one operating the mower 100 while the mower is in a normal operating configuration, e.g., while the mower 100 is positioned such that the wheels 106 and 108 rest upon the horizontal ground surface 107. These terms are used herein to simplify the description, however, and not to limit the scope of the invention in any way.

FIG. 2 is a bottom plan view of the cutting deck 200. The cutting deck 200 is illustrated and described herein as incorporating three spindles 204, each operable to support and drive one of the cutting blades 202. However, those of skill in the art will realize that the invention could equally be applied to rotary mowers having more or less spindles/blades. The deck 200 may form a downwardly opening housing defined by a first or upper surface 206 and one or more sidewalls 208 extending from the upper surface. In the illustrated embodiment, the deck 200 may include a front sidewall 208f (see FIG. 1), one or more rear sidewalls 208r, and a lateral sidewall 208t (collectively referred to as sidewalls 208). Each sidewall 208f, 208r, and 208t may depend from a respective peripheral edge (e.g., front edge, rear edge, and side edge, respectively) of the upper surface 206, and extend towards the ground surface 107.

Each cutting blade 202 may rotate within a cutting chamber 210 that may be defined, in part, by the housing formed by the upper surface 206 and the sidewalls 208. Each cutting chamber 210 may further be defined by interior skirts 212. The interior skirts 212 may be attached to the upper surface 206 and extend downwardly therefrom. The skirts 212 may be positioned in close proximity to an outermost portion of the cutting blades 202, e.g., along the periphery of the cutting chambers 210, as illustrated in FIG. 2. The skirts 212, like the sidewalls 208, extend downwardly in a generally perpendicular direction from the upper surface 206. Moreover, like the sidewalls 208 and upper surface 206, the skirts 212 may be made of a generally rigid material, e.g., steel or aluminum. In some embodiments, the skirts 212 could be incorporated into the sidewalls 208, e.g., the sidewalls 208 may be configured in close proximity to the blades, negating the need for separate interior skirts. With the inclusion of blow-out baffles as further described and illustrated herein, the skirts 212 may be shorter (terminate higher above the ground surface) than known vertical baffle configurations.

The deck 200 may exclude a sidewall on one lateral side so that an optional side discharge chute 214 is available for operation of the mower 100 in a side discharge mode (the mower could, alternatively, include a rear discharge chute). Although not shown, an optional vacuum or bagging system may be coupled to the chute 214, if desired, to assist with operation in a bagging mode. Still, further, the cutting deck 200 may operate in a mulching mode by plugging the discharge chute 214 with an optional mulch plug or plate (not shown).

In accordance with embodiments of the present invention, the cutting deck 200 may further include a blow-out baffle assembly 250. In the illustrated embodiment, the baffle assembly 250 may include two elongate baffles 252a and 252b (collectively referred to herein as baffles 252), and hardware 254 to attach the baffles to the cutting deck 200. Each baffle 252 may be configured as an elongate member that spans across a portion of the front of the cutting deck 200. While illustrated and described herein as provided on the front of the cutting deck 200, embodiments that locate baffles on other sides (e.g., the rear side) of the deck are also possible without departing from the scope of the invention.

The suffixes “a” and “b” may be used throughout this description to denote right and left side parts of the baffle assembly 250 (e.g. baffles 252), respectively. Except where otherwise identified (e.g., cutouts 260 described below), the baffle 252a may be substantially identical to the baffle 252b. Therefore, where appropriate, the baffles may be referred to generically or collectively without the suffixes “a” and “b,” e.g., “baffle 252 ” may refer to either or both baffle 252a and the baffle 252b. Moreover, it is understood that, unless otherwise noted, the description of one baffle, e.g., the description of the baffle 252a, also applies to the other baffle, e.g., the baffle 252b.

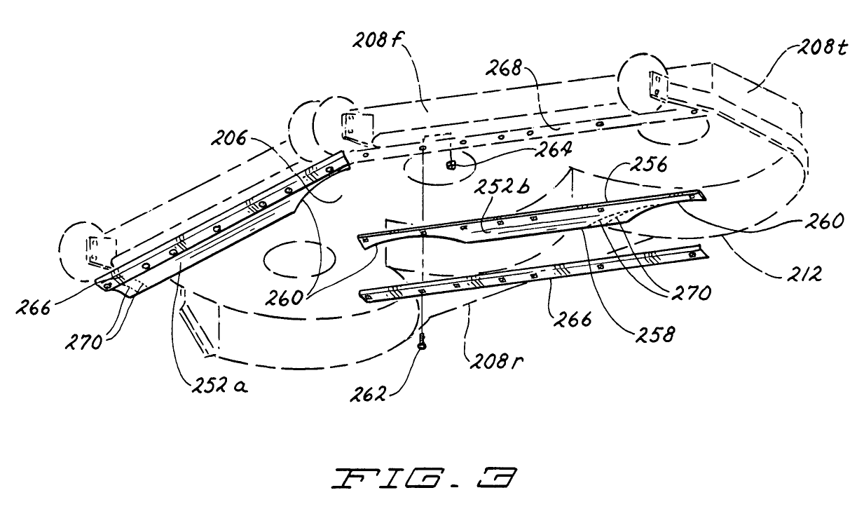

FIG. 3 illustrates a partially exploded, lower perspective view of the cutting deck 200 with some structure removed for clarity. In this particular embodiment, each baffle 252 may include an elongate first or leading edge 256. The hardware 254 may be used to attach each baffle 252, at or near its respective leading edge 256, to a lower portion of the front sidewall 208f. The leading edge 256 may be generally flush with the front sidewall 208f or, alternatively, may protrude forward of the cutting deck 200.

In a first, relaxed position, each baffle 252 may be relative flat and, when installed, generally horizontal or otherwise parallel to the upper surface 206. As a result, an elongate second or trailing edge 258 may be suspended beneath the upper surface 206 of the deck 200, e.g., the trailing edge may lie rearwardly of the front sidewall 208f. To ensure that the baffles 252 do not interfere with rotation of the cutting blades 202, the trailing edge 258 of each baffle 252 may include notches or cutouts 260. The cutouts 260 are preferably located and sized to correspond to a path of a distal tip of the respective cutting blades 202 (see FIG. 2), e.g., the cutouts 260 are slightly offset from the arc of the respective tips of the cutting blades 202 so that, regardless of the position (deflection) of the resilient baffles 252, the blades may rotate without contacting the baffles 252. In alternative embodiments, the baffles 252 could be positioned a sufficient distance from the cutting blades 202 such that the cutouts 260 would not be required.

While the hardware 254 used to secure the baffles 252 to the cutting deck 200 may be of most any acceptable configuration, it may include, in one embodiment, multiple fasteners, e.g., bolts 262 and corresponding nuts 264 (only one of each shown in FIG. 3) and one or more clamp members, e.g., skid strips 266. Each baffle 252 may be sandwiched between a lower edge, e.g., a mounting surface 268, of the cutting deck 200, and the corresponding skid strip 266. The bolts 262 may then pass through aligned openings in the skid strip 266, the baffle 252, and the mounting surface 268 and threadably engage the nuts 264. Alternatively, the mounting surface 268 could be threaded, negating the need for nuts 264.

The skid strips 266 may assist in distributing the fastener clamp load over the entire length of the respective baffles 252. However, where the fastener openings through the baffles 252 are sufficiently reinforced, the skid strips may be optional. Moreover, other clamping members, e.g., washers, could be used in place of the skid strips 266 if desired.

In some embodiments, the cutouts 260 may be precut in the baffles 252 during manufacturing. In other embodiments, baffles 252, or entire baffle kits/assemblies 250, may be configured for use with a wide variety of mower sizes. For example, each baffle 252 may include perforations or demarcations 270 (see, e.g., FIGS. 2 and 3) indicating the appropriate baffle length and cutout locations for numerous decks widths (e.g., 52, 60, and 72 inch). The skid strips 266 may include similar markings for different mower widths. As a result, the skid strips 266 (length) and baffles 252 (length and cutout 260 locations) may be easily cut by an end user at the time of installation based upon the particular cutting deck 200.

After appropriately tightening the bolts 262, the baffles 252 are preferably held firmly in place proximate their respective leading edges 256. The trailing edges 258, however, are preferably free and unsupported. That is, each baffle 252 may be cantilevered (supported in a cantilevered fashion) at its leading edge 256.

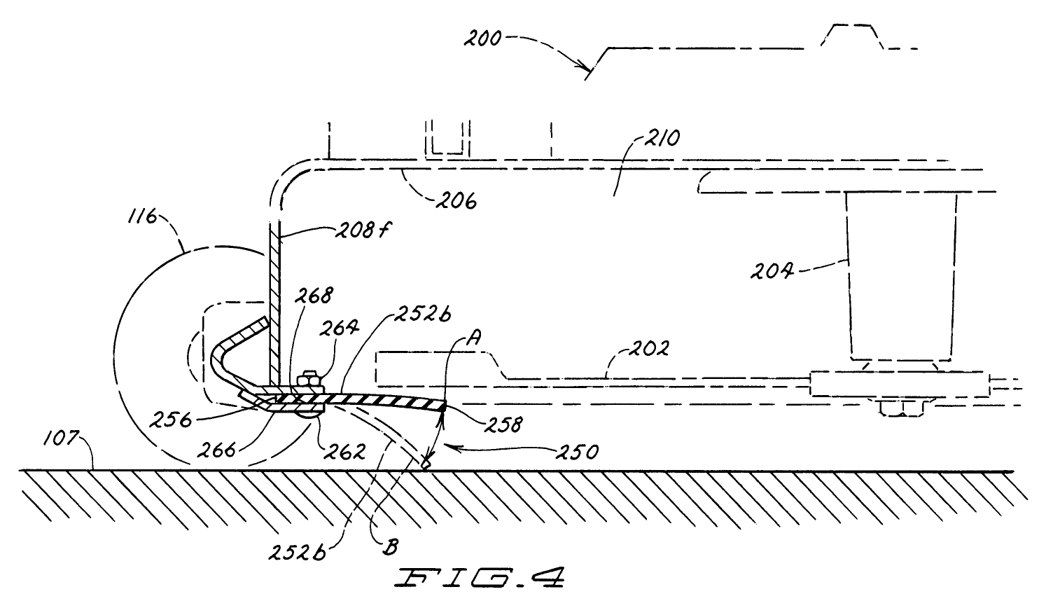

FIG. 4 is a cross-section taken along line 4-4 of FIG. 2 illustrating the baffle assembly 200, e.g., baffle 252, after installation. As stated above, each baffle 252 may be cantilevered at its leading edge 256 such that the trailing edge 258 of each baffle 252 is suspended beneath the upper surface 206, e.g., the trailing edges extend towards the cutting chamber 210. In the illustrated embodiments, the baffle 252 may, in a first or undeflected configuration (identified as configuration “A” in FIG. 4), extend generally horizontally, e.g., generally parallel to the upper surface 206. In the first configuration A, the trailing edge 258 of the baffle 252 may be located a first distance or height from the ground surface 107 as shown in FIG. 4.

As further described below, the baffle 252 may, under certain circumstances, move towards a second deflected configuration B (identified as position “B”). In the second configuration B, the trailing edge 258 of the baffle 252 moves to a second distance or height from the ground surface 107, wherein the second distance is less than the first distance. Stated another way, the trailing edge 258 of the baffle may move to an elevation that is between the elevation of the leading edge 256 and that of the ground surface 107. Preferably, the second distance is about zero inches. That is, when the baffle 252 is in the second configuration B, the trailing edge 258 may contact the ground surface 107, at least at those portions of the trailing edge that do not have a cutout 260 formed therein. In the illustrated embodiments, the baffles 252 may move between the A and B configurations via baffle deflection.

The term “ground surface,” as used herein, may refer to both generally continuous surfaces (e.g., dirt) and discontinuous surfaces (e.g., turf). With respect to the latter, “ground surface” may refer to an imaginary or effective turf surface that is located at an elevation at or below the tops of the grass blades but above the soil surface.

Due to the cantilevered mounting and the material properties of the baffle 252 (e.g., thickness, stiffness, etc.), as well as repeated deflection over time, the baffles may, in reality, sag slightly in their undeflected configuration A as illustrated in FIG. 4. However, this does not adversely affect the ability of the baffle to reduce blow-out. Moreover, for purposes of this discussion, baffles displaying such minor sagging are still considered to be generally planar (e.g., generally horizontal, or generally parallel to the upper surface 206) when in the A configuration of FIG. 4.

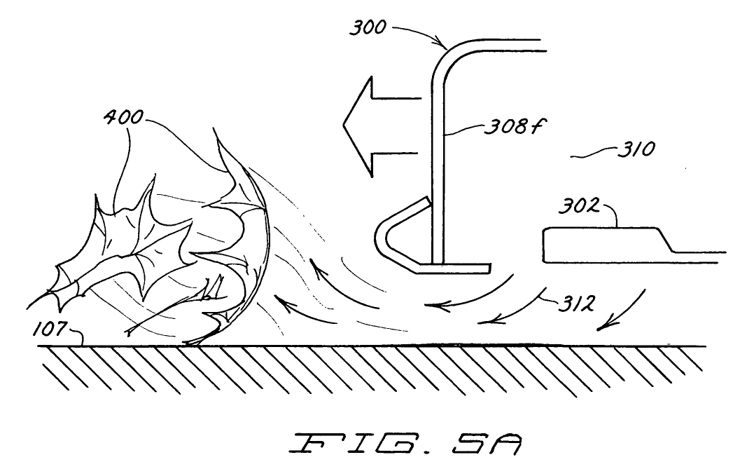

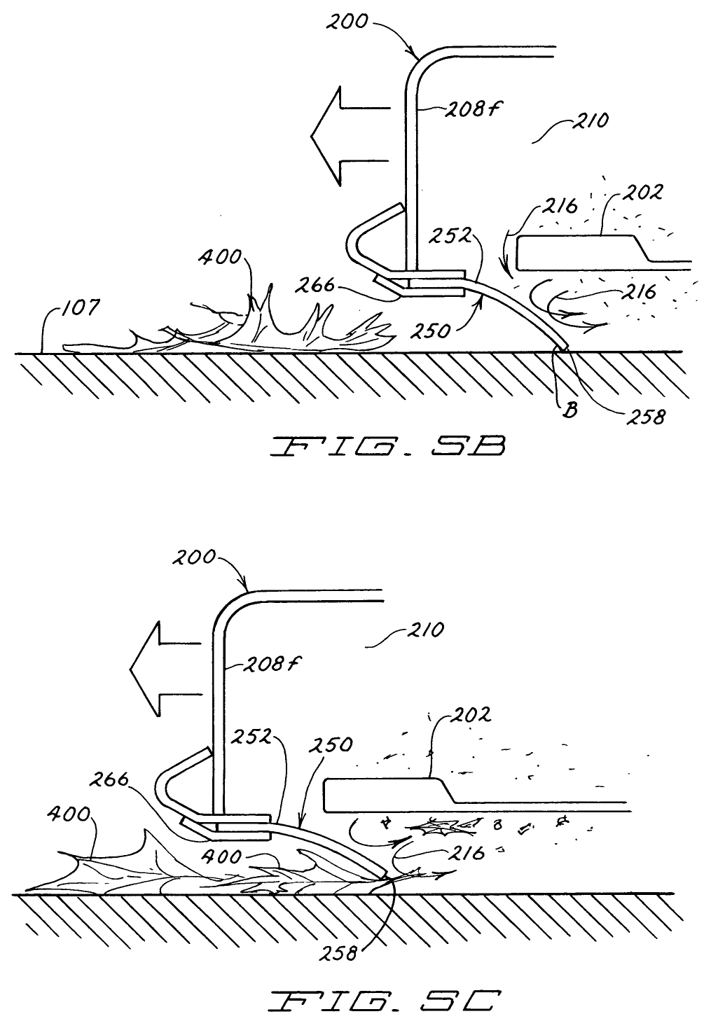

FIG. 5A illustrates a mower deck 300 (some structure removed for clarity) having a front sidewall 308f and at least one cutting blade 302 operable to rotate within a cutting chamber 310. However, the deck 300 does not include a blow-out baffle assembly 250 in accordance with embodiments of the present invention. During operation of the cutting deck 300, the blades 302 may rotate at a speed sufficient to sever grass and other vegetation (e.g., leaves 400) growing, or otherwise located, on the ground surface 107. The blades 302 create substantial air flow 312 within the cutting chamber 310. Normally, this air flow may have a net movement outwardly and downwardly from the center of the cutting chamber 310. Air that strikes the sidewalls (e.g., sidewall 308f ) or a rigid vertical baffle (not shown) may move downwardly along the sidewalls where it may then escape from (blow-out) underneath, e.g., between the sidewalls and the ground surface 107. This airflow pattern 312 may cause blow-out of debris (e.g., leaves 400) proximate the front of the deck 300.

FIGS. 5B and 5C illustrate the deck 200 as shown in FIGS. 1-4 (some structure removed for clarity), i.e., a deck incorporating a blow-out baffle assembly 250, and further identify an exemplary method of using the same. When the cutting blade 202 is powered or otherwise activated and the deck 200 is moved over the ground surface 107, an air flow pattern 216 generated within the cutting chamber 210 may cause the baffle 252 to move towards the second deflected configuration B as shown in FIGS. 4 and 5B. In this position, the baffle 252 may effectively “seal” against the ground surface 107, thereby substantially reducing blow-out of debris by reducing excessive air flow expulsion out from underneath the sidewall, e.g., front sidewall 208f. Yet, as FIG. 5C illustrates, the flexible material from which the baffle 252 is made may permit sufficient baffle deflection upwardly from the ground surface 107 to permit debris, e.g., leaves 400, to enter the cutting chamber 210 when encountered. When the air flow 216 is terminated, e.g., when the blade 202 is deactivated, the baffle 252 may return to its first undeflected configuration A.

The term “sealing,” as used herein, does not necessarily indicate an air-tight seal. Rather, “sealing” between the baffle and the ground surface indicates that any resulting gap between the trailing edge 258 of the baffle and the ground surface 107 (when the baffle 252 is in the second configuration B) is of a size that restricts blow-out of a substantial portion of air and lawn debris, e.g., leaves, from the mower deck 114.

The gap between the trailing edge 258 and the ground surface 107 may locally increase as a result of the cutouts 260, i.e., the baffles 252 may not contact or seal with the ground surface across the entire transverse width of the cutting deck 200. However, the cutout portions of the baffles make up a relatively small percentage of the width of the deck 200. Thus, the baffles 252 may assist in containing a substantial portion of air and debris that may otherwise blow-out.

While each baffle 252 is shown and described as being generally horizontal (see, e.g., FIGS. 2 and 3), it may, in other embodiments, extend from the deck 200 at other angles. This may be accomplished, for example, by providing the mounting surface 268 (see FIG. 4) at a slight angle from horizontal. However, it is preferable that each baffle 252 be configured such that, in its first configuration A (see FIG. 4), it is less than 90 degrees from horizontal, more preferably less than about 60 degrees, and most preferably, less than about 20 degrees, e.g., about zero to about 5 degrees. As a result, air flow during deck operation may result in adequate deflection of the baffles 252 such that they may approach or contact the ground surface 107. If the baffles 252 are positioned, in their first configuration A, in a vertical orientation, resulting air pressure may push the second edge 258 of the baffles out from underneath the deck, thereby limiting blow-out containment.

While not wishing to be bound to any particular configuration, each baffle 252 may, in one embodiment, be made of a resilient, flexible material that permits the baffle to deflect as described herein. For example, in one embodiment, each baffle 252 may be made from rubber, e.g., neoprene rubber, having a durometer of about 60 Shore A, a thickness of about 0.19 inches, and a depth (distance from leading edge 256 to trailing edge 258 in FIG. 4) of about 3.75 inches (each cutout 260 may reduce the depth locally by, for example, up to 3 inches). Such a material may provide not only the desired flexibility, but also sufficient durability and reliability. Those of skill in the art, however, will realize that these properties and characteristics are merely exemplary and that baffles of most any size and material (e.g., plastic, fabric, foam) are possible without departing from the scope of the invention.

Moreover, baffle assemblies of other configurations are also possible. For example, the baffles could be made from a more rigid material and attach to the front sidewall 208f of the cutting deck 200 via a pivot, e.g., a biased pivot incorporating a torsion spring. In such an embodiment, air flow generated by the cutting blades could be sufficient to overcome the bias of the torsion spring, thereby pivoting the baffles such that the trailing edges move towards the ground surface. In still other embodiments, a rigid or flexible baffle could have a leading edge pivotally attached to the deck and an unsupported trailing edge that falls to (and seals with) the ground surface as a result of the baffle's own weight. Such a baffle could pivot upwardly when objects or debris are encountered.

Baffles as shown and described herein thus provide an effective and durable mechanism for substantially reducing deck blow-out while permitting entry of debris encountered during mowing. Moreover, because of their ability to move and/or flex, baffles in accordance with the present invention may also substantially reduce or prevent turf and/or deck damage resulting from baffle contact with the ground surface. Still further, baffles as shown and described herein may be easily modified by the end user to fit decks of varying widths and blade configurations.

Exemplary embodiments of the present invention are described above. Those skilled in the art will recognize that many embodiments are possible within the scope of the invention. Other variations, modifications, and combinations of the various parts and assemblies can certainly be made and still fall within the scope of the invention. Thus, the invention is limited only by the following claims, and equivalents thereto.

1. A deck assembly for cutting vegetation, the deck assembly comprising:
an upper surface;
a sidewall extending from the upper surface towards a ground surface, wherein the upper surface and the sidewall partially surround one or more cutting chambers each operable to contain a cutting blade; and
an elongate baffle clamped, with a clamp member, to a lower edge of the sidewall such that a first elongate edge of the baffle is at or near a lower edge of the sidewall, and a second elongate edge of the baffle is suspended beneath the upper surface, the baffle operable to move between a first configuration, in which the second elongate edge is at a first distance from the ground surface, and a second configuration, in which the second elongate edge is at a second distance from the ground surface, wherein the second distance is less than the first distance.

2. The deck assembly of claim 1, wherein the sidewall extends downwardly from a front peripheral edge of the upper surface.

3. The deck assembly of claim 1, wherein the baffle comprises rubber.

4. The deck assembly of claim 1, wherein the second elongate edge comprises one or more cutouts located to correspond to a path of a distal tip of the cutting blade.

5-6. (canceled)

7. The deck assembly of claim 1, further comprising fasteners operable to secure the clamp member and the elongate baffle to the sidewall.

8. The deck assembly of claim 1, wherein movement of the elongate baffle between the first configuration and the second configuration results from deflection of the baffle.

9. The deck assembly of claim 8, wherein the second elongate edge contacts the ground surface when the baffle is in the second configuration.

10. A deck assembly for cutting vegetation, the deck assembly comprising:
an upper surface;
a sidewall extending away from the upper surface towards a ground surface, wherein the upper surface and the sidewall partially surround one or more cutting chambers each operable to contain a cutting blade; and
a cantilevered baffle comprising a first elongate edge, the baffle fixed to the sidewall such that the first elongate edge is at or near a lower edge of the sidewall and a second elongate edge of the baffle is suspended beneath the upper surface, the baffle being operable to deflect between a first configuration, wherein the second elongate edge of the baffle is located at a first distance above the ground surface, and a second configuration, wherein the second elongate edge is at a second distance above the ground surface, the first distance being greater than the second distance.

11. The deck assembly of claim 10, wherein the baffle deflects from the first configuration to the second configuration under influence of air flow generated by rotation of the cutting blade.

12. The deck assembly of claim 10, wherein the second elongate edge comprises cutouts located to correspond to an arc of a distal tip of the cutting blade.

13. A deck assembly for cutting vegetation, the deck assembly comprising:
an upper surface;
a sidewall depending from a front edge of the upper surface and extending downwardly towards a ground surface, wherein the upper surface and the sidewall partially surround one or more cutting chambers each operable to contain a cutting blade; and
a baffle assembly comprising a cantilevered baffle, the baffle comprising a first elongate edge fixed at or near a lower edge of the sidewall such that a second elongate edge of the baffle is suspended beneath the upper surface, wherein the baffle is operable to deflect between a first configuration, where the second elongate edge is located at a first height above the ground surface, and a second configuration, wherein the second elongate edge is at a second height above the ground surface, wherein the first height is greater than the second height.

14. The deck assembly of claim 13, wherein the baffle deflects from the first configuration to the second configuration under influence of air flow generated from rotation of the cutting blade.

15. The deck assembly of claim 13, wherein the second elongate edge comprises cutouts located to correspond to an arc of a distal tip of the cutting blade.

16. The deck assembly of claim 13, wherein the second elongate edge contacts the ground surface when the baffle is in the second configuration.

17. The deck assembly of claim 13, wherein the baffle assembly comprises two baffles.

18. A deck assembly for cutting vegetation, the deck assembly comprising:
an upper surface,
a sidewall coupled to a front peripheral edge of the upper surface and extending towards a ground surface, wherein the tipper surface and the sidewall partially surround one or more cutting chambers each operable to contain a cutting blade; and
a baffle assembly comprising a baffle, the baffle comprising a first elongate edge operatively attached to a lower portion of the sidewall, and a second elongate edge in or near the one or more cutting chambers, wherein the baffle is operable to move from a first configuration, wherein the baffle is generally horizontal, to a second configuration, wherein the second elongate edge of the baffle is at elevation between the elevation of the first elongate edge and that of the ground surface.

19. The deck assembly of claim 18, wherein the baffle moves between the first configuration and the second configuration by deflecting.

20. The deck assembly of claim 18, wherein the baffle assembly comprises two baffles.

21. The deck assembly of claim 18, wherein the baffle assembly comprises a clamp member operable to attach the first elongate edge of the baffle to the sidewall.

22. A method for operating a cutting deck assembly, the method comprising:
positioning the cutting deck assembly over a ground surface, the cutting deck assembly comprising:
an upper surface;
a sidewall extending away from the upper surface towards the ground surface, wherein the upper surface and the sidewall partially surround one or more cutting chambers each operable to contain a cutting blade; and
an elongate baffle operatively coupled to one or both of the upper surface and the sidewall, the clongate baffle comprising a first elongate edge positioned at or near a lower edge of the sidewall, and a second elongate edge suspended beneath the upper surface;
rotating the cutting blade: and
deflecting the baffle from a first configuration, in which the second elongate edge is at a first distance from the ground surface, to a second configuration, in which the second elongate edge is at a second distance from the ground surface, wherein the second distance is less than the first distance.

23. (canceled)

24. The method of claim 22, wherein deflecting the baffle comprises deflecting the baffle via air flow generated by rotation of the cutting blade.

25. The method of claim 22, further comprising preventing blow-out of debris from the cutting deck assembly with the baffle.

26. The method of claim 22, further comprising moving the baffle back towards the first configuration sufficiently to permit entry of debris that are encountered on the ground surface into the one or more cutting chambers.
